(19) United States
(12) Patent Application Publication
(10) Pub. No.: US 2022/0119618 A1
(43) Pub. Date: Apr. 21, 2022

(54) Recycling a Superabsorbent Polymer Using Hydrothermal Treatment

(71) Applicant: The Procter & Gamble Company, Cincinnati, OH (US)

(72) Inventor: Dimitris Ioannis Collias, Mason, OH (US)

(21) Appl. No.: 17/498,781

(22) Filed: Oct. 12, 2021

Related U.S. Application Data
(60) Provisional application No. 63/092,612, filed on Oct. 16, 2020.

(51) Int. Cl. C08J 11/14; C08F 120/06

(52) U.S. Cl. CPC C08J 11/14; C08J 2333/02; C08F 120/06

(57) ABSTRACT

Poly(acrylic acid)-based superabsorbent polymer (SAP) in a feed stream is converted into poly(acrylic acid) (PAA) in a hydrothermal treatment (HTT) reactor. The total energy used to degrade the SAP into PAA is less than about 50 MJ/kg SAP.

### FIELD OF THE INVENTION

The present invention generally relates to recycling a poly(acrylic acid)-based superabsorbent polymer (SAP) using hydrothermal treatment (HTT). More specifically, a feed stream comprising water and SAP is fed into an HTT reactor, where the temperature and pressure are such that the water is converted into a high temperature and pressure water (HTPW). In the conditions of the HTT reactor, the HTPW degrades such SAP and produces a product stream, which comprises essentially poly(acrylic acid) (PAA). The concentration of SAP in the feed stream is greater than about 1 wt %, and the total energy used to convert SAP to PAA is less than about 50 MJ/kg SAP.

### BACKGROUND OF THE INVENTION

Recycling of absorbent hygiene products (AHPs) (i.e., baby diapers, feminine protection pads, and adult incontinence pads) is good for the environment and needed to achieve the sustainability goals of many consumer companies. These goals are about using 100% recycled materials and having zero consumer and manufacturing waste go to landfill. In addition to these goals, successful recycling benefits the environment, stimulates the economy, improves people's health and water quality, and generates energy needed by consumers in developing regions of the world.

The major component in AHPs is typically the superabsorbent polymer (SAP), whereas other components are adhesives, cellulose fibers, polyethylene, polypropylene, and polyester. SAP is a water-absorbing, water-swellable, and water-insoluble powdered solid which is a crosslinked and partially neutralized homopolymer of glacial acrylic acid. SAP has an exceptionally high ability to absorb aqueous liquids, such as contaminated water or urine. About 97% of SAP produced today is used in AHP applications, whereas the remainder about 3% is used in other applications, such as agricultural or horticultural water-retaining agents, and industrial waterproofing agents.

Recycling of AHPs involves cleaning of the AHPs from the soils accumulated during their use and separating the various components into recycled material streams. More specifically, the recycled

SAP material stream can be used in applications less demanding than AHPs (since the recycled SAP has inferior properties compared to virgin SAP; for example, agricultural or horticultural water-retaining agents, and industrial waterproofing agents) and/or can be converted to essentially non-crosslinked, and slightly branched or linear poly(acrylic acid) (PAA). Then, this PAA can be used as a feed material to various applications. For example, the PAA can be: 1) used as-is in applications such as water treatment or corrosion inhibition; or 2) esterified and then used in adhesives, coatings, etc.; or 3) re-polymerized and re-crosslinked back to SAP; or 4) blended with virgin SAP. The first two sets of applications are part of the effort to recycle SAP into other products by replacing virgin acrylic-acid-based compounds with compounds derived from recycled SAP, whereas the last two sets of applications are part of the circular economy of SAP, i.e., recycling SAP back to SAP. In all cases, the objective is to achieve the same properties as virgin materials.

Non-limiting examples of processes that produce purified and separated material streams of used SAP from recycled AHPs are disclosed and claimed in U.S. Pat. No. 9,095,853 B2, issued on Aug. 4, 2015; and U.S. Pat. No. 9,156,034 B2, issued on Oct. 13, 2015; both assigned to Fater S.p.A, based in Pescara, Italy.

Most SAPs are based on poly(acrylic acid) and are crosslinked network materials. Non-limiting examples of procedures used to produce SAPs from glacial acrylic acid and crosslinkers are disclosed in U.S. Pat. No. 8,383,746 B2, issued on Feb. 26, 2013, and assigned to Nippon Shokubai Co., Ltd, based in Osaka, Japan; and U.S. Pat. No. 9,822,203 B2, issued on Nov. 21, 2017, and assigned to BASF SE, based in Ludwigshafen, Germany.

Ultrasonic degradation of SAP is described in: (1) Ebrahimi, R., et al., Organic Chemistry Intl, 2012, Article ID 343768, 5 pages; and (2) Shukla, N. B., and Madras, G., J. Appl. Polym. Sci., 125 (2012), 630-639. Ultrasonic degradation of PAA is described in: (1) Shukla, N. B., et al., J. Appl. Polym. Sci., 112 (2009), 991-997; and (2) Prajapat, A. L., and Gogate, P. R., Ultrason. Sonochem., 32 (2016), 290-299. Also, a general description of ultrasonic degradation of polyers in solution is given in: Basedow, A. M., and Ebert, K. H., Adv. Polym. Sci., 22 (1977), 83-148.

For the degradation of SAPs, both references used viscosity as a measure of the degradation level and found that it takes about 5 to 10 min to reduce the viscosity by one order of magnitude, e.g., from 10 Pa·s to 1 Pa·s, which indicates that a lot of energy is needed to achieve that level of degradation. For the degradation of linear polymers, the main themes from these references (as well as other references that report on the use of UV, thermal, and other forms of energy) are that the (1) preferential scission is at the mid-point of the polymer chain, (2) the higher molecular weight chains are degraded at a higher rate than the lower molecular weight chains, and (3) there is a minimum molecular weight below which degradation or de-polymerization does not occur. In all cases, the ultrasonic degradation of polymers is due to cavitation, and fast growth and collapse of the resulting microbubbles.

Accordingly, there is a need to recycle AHPs and their major component, which is SAP. For the recycling of SAP, there is a need to degrade SAP into poly(acrylic acid) (PAA), in short time scale; with low energy and power per unit mass of SAP; and with avoiding decarboxylation of the degraded SAP. The requirement for low energy per unit mass of SAP stems from the fact that the recycling of used SAP and its degradation to PAA is beneficial only if the energy spent during the converting of SAP to PAA is less than that used to make fossil-derived acrylic acid (petro-AA) from propylene, which is about 50 MJ/kg AA. The PAA produced from SAP can then be incorporated back into virgin SAP (thus increasing its recycled content and supporting the circular economy of SAP) and/or derivatized into materials for other applications, such as, adhesives, coatings, water treatment, fabric care, etc.

### SUMMARY OF THE INVENTION

In embodiments of the present invention, a method for degrading a superabsorbent polymer (SAP) to poly(acrylic acid) (PAA) is presented. The method comprises flowing a feed stream comprising water and said SAP into an inlet of a hydrothermal treatment (HTT) reactor and producing a product stream comprising said PAA at an outlet of said HTT reactor; wherein said HTT reactor is at an HTT reactor temperature and at an HTT reactor pressure; wherein said HTT reactor temperature is higher than about 250° C. and said HTT reactor pressure is higher than about 1 MPa; wherein said SAP in said feed stream is at a concentration greater than about 1 wt %; and wherein said degradation of said SAP to said PAA requires a total energy of less than about 50 MJ/kg SAP.

In embodiments of the present invention, a method for degrading a superabsorbent polymer (SAP) to poly(acrylic acid) (PAA) is presented. The method comprises flowing a feed stream comprising water and said SAP into an inlet of an HTT reactor and producing a product stream comprising PAA at an outlet of said HTT reactor; wherein said HTT reactor is at an HTT reactor temperature and at an HTT reactor pressure; wherein said HTT reactor temperature is higher than about 250° C. and said HTT reactor pressure is higher than about 1 MPa; wherein said SAP in said feed stream is at a concentration greater than about 1 wt %; wherein said degradation of said SAP to said PAA requires a total energy of less than about 16 MJ/kg SAP; and wherein said PAA has a weight-average molecular weight less than about 1,000,000 g/mol.

In embodiments of the present invention, a method for degrading a superabsorbent polymer (SAP) to poly(acrylic acid) (PAA) is presented. The method comprises flowing a feed stream comprising water and said SAP into an inlet of an HTT reactor and producing a product stream comprising PAA at an outlet of said HTT reactor; wherein said HTT reactor is at an HTT reactor temperature and at an HTT reactor pressure; wherein said HTT reactor temperature is higher than about 374° C. and said HTT reactor pressure is higher than about 22.064 MPa; wherein said SAP in said feed stream is at a concentration greater than about 5 wt %; wherein said degradation of said SAP to said PAA requires a total energy of less than about 16 MJ/kg SAP; and wherein said PAA has a weight-average molecular weight less than about 1,000,000 g/mol.

### DETAILED DESCRIPTION OF THE INVENTION

### I Definitions

As used herein, the term “SAP” refers to crosslinked, partially neutralized, and poly(acrylic acid)-based superabsorbent polymer. SAP examples are disclosed in U.S. Pat. Nos. 8,383,746 B2 and 9,822,203 B2. Typically, SAP is capable of absorbing a 0.9 wt % saline solution at 25° C. at least 10 times its dry weight. The typical absorption mechanism is osmotic pressure. SAP that absorbs water or aqueous solutions becomes a gel.

As used herein, the term “degree of neutralization” or “DN” refers to the mol percentage of the acid groups in SAP or PAA that are neutralized by the reaction with a base (typically, sodium hydroxide). A typical method to measure the DN of an SAP is to measure the Na content using the Inductively Coupled Plasma (ICP) analytical technique, as it is well known to those skilled in the art. If the amount of Na is wt % (Na), then the degree of neutralization is calculated as DN=100×72/((23×100/wt % (Na))−22 ).

As used herein, the term “poly(acrylic acid)” or “PAA” or “polymer of acrylic acid” refers to an essentially non-crosslinked, and either slightly branched or linear poly(acrylic acid) molecule with acrylic acid as the monomeric unit and degree of polymerization that can be 2 or higher. For the purposes of the present invention, there will be no difference between a polymer of acrylic acid and an oligomer of acrylic acid.

As used herein, the term “degradation” refers to the conversion of SAP into PAA via the actions of partial de-polymerization, de-crosslinking, molecular backbone breaking, or any combination of the above actions. For the purposes of the present invention, the terms “degradation”, “recycling”, and “conversion” are used interchangeably, as long as they refer to the transformation of SAP to PAA. Also, the degradation essentially preserves the carboxylic groups of the SAP and thus the product PAA contains those carboxylic groups. Note that full de-polymerization of SAP should lead to acrylic acid (AA).

As used herein, the term “virgin SAP” refers to SAP produced from virgin glacial acrylic acid, which is the feedstock used today to make SAP. Virgin acrylic acid can be produced from either fossil-derived propylene or other bio-derived materials (non-limiting examples of bio-materials are: lactic acid, 3-hydroxypropionic acid, glycerin, bio-propylene, carbon dioxide, and sugar). Virgin SAP does not include any recycled SAP above about 1 wt %.

As used herein, the term “used SAP” refers to SAP which has already been produced industrially and/or used commercially, for example, in a baby diaper, feminine pad, adult incontinence pad, or other articles and/or uses. Used SAP can be post-consumer SAP (PCR SAP), post-industrial SAP (PIR SAP), or combinations of both. Unless otherwise noted in this invention, SAP refers to either “used SAP” or “virgin SAP”.

As used herein, the term “degraded SAP” refers to SAP which has been degraded to PAA. For the purposes of the present invention, the terms “degraded SAP” and “PAA” are used interchangeably.

As used herein, the term “recycled SAP” refers to SAP which contains at least 1 wt % degraded SAP (or equivalently, PAA) that has been incorporated into the SAP while the SAP is being produced from glacial acrylic acid using the typical production method. Thus, the recycled SAP is a blend of virgin SAP and at least 1 wt % degraded SAP.

As used herein, the term “feed stream” refers to a body of fluid that flows in a specific direction and feeds into an inlet of a reactor.

As used herein, the term “product stream” refers to a body of fluid that is produced at an outlet of a reactor when the feed stream is fed into an inlet of the same reactor.

As used herein, the terms “viscosity ratio” or “viscosity reduction ratio” refer to the ratio of the viscosity of the product stream to that of the feed stream. The viscosity of the feed stream is typically measured with a parallel plate fixture in oscillatory mode, and the complex viscosity reported typically corresponds to a frequency of 1 rad/s. The viscosity of the product stream is measured with either a cup and bob fixture in steady mode or parallel plate fixture in oscillatory mode. When the viscosity is measured with a cup and bob fixture in steady mode the viscosity reported typically corresponds to a shear rate of 4 s⁻¹. These viscosity measurement techniques are well known to those skilled in the art. For the purposes of the present invention, the negative of the logarithm of the viscosity ratio indicates the extent of the SAP degradation to PAA in orders of magnitude, as it is accepted by those skilled in the art that the lower the viscosity of a PAA solution the lower the molecular weight of the PAA is, at a fixed concentration.

As used herein, Mₙ is the number average molecular weight, in g/mol or equivalently Da, M_{w} is the weight average molecular weight, in g/mol or equivalently Da, M_{z} is the z-average molecular weight, in g/mol or equivalently Da, and PDI is the polydispersity index defined as M_{w}/Mₙ.

### II Feed Stream

Unexpectedly, it has been found that SAP degrades to PAA (i.e., essentially, without decarboxylation) when the SAP feed stream (which is in the form of an aqueous gel) flows in an HTT reactor operating at temperature between about 250° C. and about 500° C., and pressure between about 0.1 MPa and about 30 MPa. At these conditions of temperature and pressure the water becomes HTPW. Also, these temperature and pressure ranges include the critical temperature (374° C.) and pressure (22.064 MPa) of water. Without wishing to be bound by any theory, applicants believe that HTPW causes breaking of the cross-linker, cross-linker attachments to the backbone, and backbone bonds.

The typical properties of SAP are mechanical properties, swelling capacity, saline flow conductivity (SFC), absorption against pressure (AAP; INDA test method WSP 242.2), residual monomer, extractable polymer (amount of extractables), and centrifuge retention capacity (CRC). Also, for the purposes of the present invention, the SAP can include other co-monomers, such as itaconic acid, acrylamide, etc., or other materials, such as starch, cellulosic fibers, clays, etc.

SAP is typically prepared using a homogeneous solution polymerization process or by multi-phase polymerization techniques, such as inverse emulsion or suspension polymerization. The polymerization reaction generally occurs in the presence of a relatively small amount of di- or poly-functional monomers, such as N,N′-methylene bisacrylamide, trimethylolpropane triacrylate, (poly) ethylene glycol di(meth)acrylate, triallylamine, etc. The di- or poly-functional monomer compounds serve to lightly crosslink the acrylate polymer chains, thereby rendering the SAP water-insoluble, yet water-swellable. Furthermore, SAP can be surface-crosslinked after polymerization by reaction with suitable crosslinking agents, such as di/poly-epoxides, di/poly-alcohols, di/poly-haloalkanes, etc. SAP is typically in particulate form, which, in the case of solution polymerization, is produced from a slab of material with any typical size reduction techniques, such as milling.

SAP can be fully un-neutralized (DN=0), fully neutralized (DN=100%), or partly neutralized. In embodiments of the present invention, the SAP has DN greater than about 50%. In embodiments of the present invention, the SAP has DN between about 65% and about 75%. In embodiments of the present invention, the SAP has DN greater than about 75%. In embodiments of the present invention, the SAP has DN lower than about 50%.

In embodiments of the present invention, the feed stream comprises SAP. In embodiments of the present invention, the feed stream comprises SAP and water. In embodiments of the present invention, the feed stream comprises SAP and ethylene glycol (EG). In embodiments of the present invention, the feed stream comprises SAP, water, and ethylene glycol. The water in the feed stream can be RO water, regular tap water, or water containing dissolved inorganic salts at various salt concentrations. A non-limiting example of water with salt is a 0.9 wt % solution of sodium chloride. Other salts with monovalent cations, but higher ionic strength, can be used to reduce the viscosity of the feed stream or alternatively to enable higher SAP concentration to be used. A non-limiting example of a viscosity reducing salt is sodium sulfate.

The feed stream can also comprise any free radical producing chemical compound. Non-limiting examples of such chemical compounds are hydrogen peroxide (H₂O₂), persulfate (such as, sodium persulfate or potassium persulfate), perborate, perphosphate, percarbonate, diazo compounds, ozone, organic free radical initiators (e.g., di-ter-butyl peroxide (DTBP)), combinations thereof, etc. In embodiments of the present invention, the feed stream comprises SAP and H₂O₂. In embodiments of the present invention, the feed stream comprises SAP and a H₂O₂ solution.

In embodiments of the present invention, the feed stream comprises SAP at a concentration greater than about 1 wt %. In embodiments of the present invention, the feed stream comprises SAP at a concentration greater than about 5 wt %. In embodiments of the present invention, the feed stream comprises SAP at a concentration greater than about 10 wt %. In embodiments of the present invention, the feed stream comprises SAP at a concentration of about 2.5 wt %. In embodiments of the present invention, the feed stream comprises SAP at a concentration of about 5 wt %. In embodiments of the present invention, the feed stream comprises SAP at a concentration of about 7.5 wt %. In embodiments of the present invention, the feed stream comprises SAP at a concentration of about 10 wt %.

In embodiments of the present invention, the feed comprises SAP and a H₂O₂ solution, and the concentration of the SAP is about 2.5 wt %, the concentration of the H₂O₂ solution is 97.5 wt %, and the concentration of the H₂O₂ in the H₂O₂ solution is less than about 3 wt %. In embodiments of the present invention, the feed comprises SAP and a H₂O₂, and the concentration of the SAP is about 5 wt %, the concentration of the H₂O₂ solution is about 95 wt %, and the concentration of the H₂O₂ in the H₂O₂ solution is less than about 3 wt %. In embodiments of the present invention, the feed comprises SAP and a H₂O₂ solution, and the concentration of the SAP is about 2.5 wt %, the concentration of the H₂O₂ solution is 97.5 wt %, and the concentration of the H₂O₂ in the H₂O₂ solution is about 3 wt %. In embodiments of the present invention, the feed comprises SAP and a H₂O₂, and the concentration of the SAP is about 5 wt %, the concentration of the H₂O₂ solution is about 95 wt %, and the concentration of the H₂O₂ in the H₂O₂ solution is about 3 wt %.

In embodiments of the present invention, the feed comprises SAP and a H₂O₂ solution, and the concentration of the SAP is about 2.5 wt %, the concentration of the H₂O₂ solution is 97.5 wt %, and the concentration of the H₂O₂ in the H₂O₂ solution is about 0.3 wt %. In embodiments of the present invention, the feed comprises SAP and a H₂O₂, and the concentration of the SAP is about 5 wt %, the concentration of the H₂O₂ solution is about 95 wt %, and the concentration of the H₂O₂ in the H₂O₂ solution is about 0.3 wt %. In embodiments of the present invention, the feed comprises SAP and a H₂O₂ solution, and the concentration of the SAP is about 2.5 wt %, the concentration of the H₂O₂ solution is 97.5 wt %, and the concentration of the H₂O₂ in the H₂O₂ solution is about 0.03 wt %. In embodiments of the present invention, the feed comprises SAP and a H₂O₂, and the concentration of the SAP is about 5 wt %, the concentration of the H₂O₂ solution is about 95 wt %, and the concentration of the H₂O₂ in the H₂O₂ solution is about 0.03 wt %.

In embodiments of the present invention, the feed comprises SAP and a H₂O₂ solution, and the concentration of the H₂O₂ in the H₂O₂ solution is less than about 3 wt %. In embodiments of the present invention, the feed comprises SAP and H₂O₂, and the concentration of the H₂O₂ in the H₂O₂ solution is less than about 0.3 wt %. In embodiments of the present invention, the feed comprises SAP and H₂O₂ solution, and the concentration of the H₂O₂ in the H₂O₂ solution is less than about 0.03 wt %.

The viscosity of the feed stream is typically measured with a parallel plate fixture in oscillatory mode, and the complex viscosity reported typically corresponds to a frequency of 1 rad/s. Depending on the SAP concentration the complex viscosity of the feed stream can be higher than 200 Pa·s (or equivalently, 200,000 cP). The feed stream can be in the form of a solution or gel, depending on the concentration of SAP.

The non-renewable energy use (NREU) to make acrylic acid (AA) from the fossil-derived propylene is estimated to be about 50 MJ/kg SAP (equivalently, 50 MJ/kg AA). Therefore, any successful recycling attempt of SAP needs to expend less energy than the NREU to make AA, i.e., less than about 50 MJ/kg SAP. For the purposes of the NREU calculations, it is assumed that the SAP is fully non-neutralized (DN=0).

### III HTT Reactor

Typically, the feed stream is in fluid communication with the HTT reactor via a tube or a channel, and a pump. Non-limiting examples of tubes or channels are glass tubes, metal tubes, alloy tubes (such as, stainless-steel tubes), and polymer tubes. The tube or channel can have any cross-sectional shape, such as, circular, rectangular, oval, rhombic, etc. Also, the size of the cross-sectional area of the tube or channel can be the same or vary along the flow direction. A non-limiting example of a varying cross-sectional shape of a tube is an undulating tube that can cause the feed stream to experience extensional stresses as it flows down the tube. These extensional stresses might be beneficial to the degradation of the SAP that is part of the feed stream. Also, the feed stream can go through static mixers or other mixing elements placed inside the tube and/or channel that the feed stream flows through. Non-limiting examples of pumps are centrifugal pumps (such as, axial, radial, and mixed flow pumps) and positive displacement pumps (such as, reciprocating, rotary, piston, diaphragm, gear, peristaltic, screw, and vane). The reactor can employ one or more pumps.

The HTT reactor can be any type known to those skilled in the art. Non-limiting examples of HTT reactors are continuous stirred tank reactor (CSTR), flow reactor, fluidized bed reactor, and packed bed reactor. The degradation of SAP can be catalytic or non-catalytic, and can proceed in continuous, batch, or semi batch modes. The metal or alloy of construction of the HTT reactor can be stainless steel, carbon steel, or any other suitable metal or alloy.

The degradation may be carried out at any suitable temperature and pressure, which are measured at the HTT reactor. In embodiments of the present invention, the HTT reactor temperature is higher than about 250° C. In embodiments of the present invention, the HTT reactor temperature is higher than about 374° C. In embodiments of the present invention, the HTT reactor temperature is between about 250° C. and about 500° C. In embodiments of the present invention, the HTT reactor temperature is higher than about 300° C. In embodiments of the present invention, the HTT reactor temperature is higher than about 350° C. In embodiments of the present invention, the HTT reactor temperature is higher than about 400° C. In embodiments of the present invention, the HTT reactor temperature is between about 425° C. and about 500° C. In embodiments of the present invention, the HTT reactor temperature is about 450° C. In embodiments of the present invention, the HTT reactor temperature is between about 390° C. and about 480° C. In embodiments of the present invention, the HTT reactor temperature is between about 400° C. and about 450° C. In embodiments of the present invention, the HTT reactor temperature is between about 420° C. and about 440° C.

In embodiments of the present invention, the HTT reactor pressure is between about 0.1 MPa and about 30 MPa. In embodiments of the present invention, the HTT reactor pressure is between about 0.2 MPa and about 25 MPa. In embodiments of the present invention, the HTT reactor pressure is between about 1 MPa and about 20 MPa. In embodiments of the present invention, the HTT reactor pressure is higher than about 0.2 MPa. In embodiments of the present invention, the HTT reactor pressure is higher than about 1 MPa. In embodiments of the present invention, the HTT reactor pressure is higher than about 3 MPa. In embodiments of the present invention, the HTT reactor pressure is higher than about 10 MPa. In embodiments of the present invention, the HTT reactor pressure is higher than about 23 MPa. In embodiments of the present invention, the HTT reactor pressure is about 0.25 MPa. In embodiments of the present invention, the HTT reactor pressure is about 1.5 MPa. In embodiments of the present invention, the HTT reactor pressure is about 3.8 MPa. In embodiments of the present invention, the HTT reactor pressure is about 23 MPa.

In embodiments of the present invention, the HTT reactor temperature is higher than about 250° C. and the HTT reactor pressure is higher than about 1 MPa. In embodiments of the present invention, the HTT reactor temperature is higher than about 374° C. and the HTT reactor pressure is higher than about 22.064 MPa.

The flowrate of the feed stream into the HTT reactor can be of any suitable value. In embodiments of the present invention, the flowrate of the feed stream into the HTT reactor exceeds about 1 L/min. In embodiments of the present invention, the flowrate of the feed stream into the HTT reactor exceeds about 10 L/min. In embodiments of the present invention, the flowrate of the feed stream into the HTT reactor exceeds about 100 L/min. In embodiments of the present invention, the flowrate of the feed stream into the HTT reactor exceeds about 1000 L/min. In embodiments of the present invention, the flowrate of the feed stream into the HTT reactor is between about 1 L/min and about 1,000 L/min. In embodiments of the present invention, the flowrate of the feed stream into the HTT reactor is between about 2 L/min and about 500 L/min. In embodiments of the present invention, the flowrate of the feed stream into the HTT reactor is between about 3 L/min and about 200 L/min. In embodiments of the present invention, the flowrate of the feed stream into the HTT reactor is between about 4 L/min and about 100 L/min. In embodiments of the present invention, the flowrate of the feed stream into the HTT reactor is about 5 L/min.

The residence time of the feed stream in the HTT reactor can be of any suitable value. The residence time is defined as the average time the feed stream spends in the HTT reactor. In embodiments of the present invention, the residence time of the feed stream in the HTT reactor is higher than about 1 s. In embodiments of the present invention, the residence time of the feed stream in the HTT reactor is higher than about 10 s. In embodiments of the present invention, the residence time of the feed stream in the HTT reactor is higher than about 100 s. In embodiments of the present invention, the residence time of the feed stream in the HTT reactor is higher than about 3 min. In embodiments of the present invention, the residence time of the feed stream in the HTT reactor is higher than about 10 min. In embodiments of the present invention, the residence time of the feed stream in the HTT reactor is higher than about 100 min. In embodiments of the present invention, the residence time of the feed stream in the HTT reactor is higher than about 1 h. In embodiments of the present invention, the residence time of the feed stream in the HTT reactor is higher than about 10 h. In embodiments of the present invention, the residence time of the feed stream in the HTT reactor is higher than about 100 h.

In embodiments of the present invention, the residence time of the feed stream in the HTT reactor is between about 1 s and about 100 s. In embodiments of the present invention, the residence time of the feed stream in the HTT reactor is between about 5 s and about 50 s. In embodiments of the present invention, the residence time of the feed stream in the HTT reactor is between about 10 s and about 30 s. In embodiments of the present invention, the residence time of the feed stream in the HTT reactor is between about 15 s and about 25 s.

The total energy is the electric energy that is supplied to the HTT reactor and is based on the voltage and amperage of the HTT reactor, and the residence time of the feed stream. The specific energy is the energy that is dissipated in the feed stream inside the HTT reactor and is used to convert SAP to PAA. The calculations for the total energy and specific energy are exemplified in the Methods section VI (as they are well known to those skilled in the art).

In embodiments of the present invention, the specific energy used to convert SAP to PAA is less than about 30 MJ/kg SAP. In embodiments of the present invention, the specific energy used to convert SAP to PAA is less than about 20 MJ/kg SAP. In embodiments of the present invention, the specific energy used to convert SAP to PAA is less than about 10 MJ/kg SAP. In embodiments of the present invention, the specific energy used to convert SAP to PAA is less than about 5 MJ/kg SAP. In embodiments of the present invention, the specific energy used to convert SAP to PAA is less than about 1 MJ/kg SAP.

In embodiments of the present invention, the total energy used to convert SAP to PAA is less than about 50 MJ/kg SAP. In embodiments of the present invention, the total energy used to convert SAP to PAA is less than about 32 MJ/kg SAP. In embodiments of the present invention, the total energy used to convert SAP to PAA is less than about 16 MJ/kg SAP. In embodiments of the present invention, the total energy used to convert SAP to PAA is less than about 10 MJ/kg SAP. In embodiments of the present invention, the total energy used to convert SAP to PAA is less than about 2 MJ/kg SAP.

The degradation of SAP using HTPW can be preceded or followed by other processes, such as microwave heating, UV irradiation, IR heating, ultrasonic/cavitation, extrusion, extensional stretching, etc.

### IV Product Stream

The feed stream flows into the inlet of the HTT reactor and produces a product stream at the outlet of the HTT reactor. In embodiments of the present invention, the product stream comprises PAA. In embodiments of the present invention, the product stream comprises PAA and SAP.

In embodiments of the present invention, the PAA has a weight-average molecular weight less than about 5,000,000 g/mol. In embodiments of the present invention, the PAA has a weight-average molecular weight less than about 2,000,000 g/mol. In embodiments of the present invention, the PAA has a weight-average molecular weight less than about 1,000,000 g/mol. In embodiments of the present invention, the PAA has a weight-average molecular weight less than about 500,000 g/mol. In embodiments of the present invention, the PAA has a weight-average molecular weight less than about 300,000 g/mol. In embodiments of the present invention, the PAA has a weight-average molecular weight less than about 200,000 g/mol. In embodiments of the present invention, the PAA has a weight-average molecular weight less than about 100,000 g/mol. In embodiments of the present invention, the PAA has a weight-average molecular weight less than about 30,000 g/mol.

In embodiments of the present invention, the PAA has a weight-average molecular weight between about 1,000,000 g/mol and about 5,000,000 g/mol. In embodiments of the present invention, the PAA has a weight-average molecular weight between about 500,000 g/mol and about 2,000,000 g/mol. In embodiments of the present invention, the PAA has a weight-average molecular weight between about 100,000 g/mol and about 1,000,000 g/mol. In embodiments of the present invention, the PAA has a weight-average molecular weight between about 150,000 g/mol and about 500,000 g/mol. In embodiments of the present invention, the PAA has a weight-average molecular weight between about 90,000 g/mol and about 300,000 g/mol. In embodiments of the present invention, the PAA has a weight-average molecular weight between about 20,000 g/mol and about 200,000 g/mol. In embodiments of the present invention, the PAA has a weight-average molecular weight between about 10,000 g/mol and about 100,000 g/mol.

In embodiments of the present invention, the PAA has a polydispersity index (PDI) less than about 10. In embodiments of the present invention, the PAA has a PDI less than about 6. In embodiments of the present invention, the PAA has a PDI less than about 4. In embodiments of the present invention, the PAA has a PDI less than about 2. PDI is the ratio of the weight-average molecular weight to the number-average molecular weight, and these molecular weights are measured by GPC (described in the Methods section VII) as it is known to those skilled in the art.

The viscosity of the product stream is typically measured with either a parallel plate fixture in oscillatory mode or a cup and bob fixture in steady mode. The oscillatory viscosity reported typically corresponds to 1 rad/s, and the steady viscosity reported typically corresponds to a shear rate of 4 s⁻¹. Depending on the PAA concentration and molecular weight, the viscosity of the product stream can be as low as 1 mPa·s (or equivalently, 1 cP; i.e., the viscosity of water).

The ratio of the viscosity of the product stream to the viscosity of the feed stream is the viscosity reduction ratio (or simply, viscosity ratio). It indicates the extent of the SAP degradation to PAA by the UV flow system. The negative logarithm of the viscosity ratio measures the orders of magnitude change between the viscosity of the feed stream and the product stream. In embodiments of the present invention, the feed stream has a viscosity; the product stream has a viscosity; the ratio of the viscosity of the product stream to the viscosity of the feed stream is the viscosity ratio; and the negative logarithm of said viscosity ratio is less than about 6. In embodiments of the present invention, the feed stream has a viscosity; the product stream has a viscosity; the ratio of the viscosity of the product stream to the viscosity of the feed stream is the viscosity ratio; and the negative logarithm of said viscosity ratio is less than about 4. In embodiments of the present invention, the feed stream has a viscosity; the product stream has a viscosity; the ratio of the viscosity of the product stream to the viscosity of the feed stream is the viscosity ratio; and the negative logarithm of said viscosity ratio is less than about 2.

PAA from the product stream can be derivatized into materials for various applications, such as, adhesives, coatings, water treatment, etc. In embodiments of the present invention, PAA from the product stream, either as is or derivatized, is used as an adhesive. In embodiments of the present invention, PAA from the product stream, either as is or derivatized, is used in fabric care applications. In embodiments of the present invention, PAA from the product stream, either as is or derivatized, is used in water treatment applications.

In embodiments of the present invention, PAA from the product stream is used as a ply glue in paper products. In embodiments of the present invention, PAA from the product stream is used as a ply glue in paper towel products. In embodiments of the present invention, PAA from the product stream is used as a ply glue in toilet paper products. In embodiments of the present invention, PAA from the product stream is used as ply glue in paper products has M_{w} greater than about 350 kDa. In embodiments of the present invention, PAA from the product stream is used as ply glue in paper products has M_{w} between about 400 kDa and about 500 kDa.

In embodiments of the present invention, PAA from the product stream is used as a glue between the paper core and paper towel products. In embodiments of the present invention, PAA from the product stream is used as a glue between the paper core and toilet paper products.

PAA can be extracted from the product stream via a number of processes. Non-limiting examples of these processes are water evaporation, PAA filtration, water extraction, etc. Also, salts present in the product stream from the use of SAP in AHPs can be removed via any desalination technique known to those skilled in the art. Non-limiting examples of desalination processes are membrane processes (e.g., reverse osmosis, forward osmosis, electrodialysis reversal (EDR), nanofiltration, etc.), freezing desalination, solar desalination, geothermal desalination, ion exchange, wave powered desalination, etc.

### V Recycled SAP

PAA from the product stream can be fed into the process to make SAP from glacial acrylic acid, thus producing recycled SAP. In embodiments of the present invention, the PAA is used to produce a recycled SAP.

In embodiments of the present invention, the SAP comprises PAA at a concentration, and wherein the PAA concentration is less than about 60 wt %. In embodiments of the present invention, the SAP comprises PAA at a concentration, and wherein the PAA concentration is less than about 50 wt %. In embodiments of the present invention, the SAP comprises PAA at a concentration, and wherein the PAA concentration is less than about 45 wt %. In embodiments of the present invention, the SAP comprises PAA at a concentration, and wherein the PAA concentration is less than about 40 wt %. In embodiments of the present invention, the SAP comprises PAA at a concentration, and wherein the PAA concentration is less than about 30 wt %. In embodiments of the present invention, the SAP comprises PAA at a concentration, and wherein the PAA concentration is less than about 20 wt %. In embodiments of the present invention, the SAP comprises PAA at a concentration, and wherein the PAA concentration is less than about 15 wt %. In embodiments of the present invention, the SAP comprises PAA at a concentration, and wherein the PAA concentration is less than about 10 wt %.

In embodiments of the present invention, the recycled SAP has an amount of extractables, and wherein the amount of extractables is less than about 20 wt %. In embodiments of the present invention, the recycled SAP has an amount of extractables, and wherein the amount of extractables is less than about 15 wt %. In embodiments of the present invention, the recycled SAP has an amount of extractables, and wherein the amount of extractables is less than about 10 wt %. In embodiments of the present invention, the recycled SAP has an amount of extractables, and wherein the amount of extractables is less than about 7 wt %.

In embodiments of the present invention, the recycled SAP has a swelling ratio, and wherein the swelling ratio is greater than about 50 g/g. In embodiments of the present invention, the recycled SAP has a swelling ratio, and wherein the swelling ratio is greater than about 45 g/g. In embodiments of the present invention, the recycled SAP has a swelling ratio, and wherein the swelling ratio is greater than about 40 g/g. In embodiments of the present invention, the recycled SAP has a swelling ratio, and wherein the swelling ratio is greater than about 35 g/g.

In embodiments of the present invention, the recycled SAP has a swelling ratio, and wherein the swelling ratio is about 50 g/g. In embodiments of the present invention, the recycled SAP has a swelling ratio, and wherein the swelling ratio is about 45 g/g. In embodiments of the present invention, the recycled SAP has a swelling ratio, and wherein the swelling ratio is about 42 g/g. In embodiments of the present invention, the recycled SAP has a swelling ratio, and wherein the swelling ratio is about 40 g/g.

In embodiments of the present invention, the recycled SAP has a CRC, and wherein the CRC is between about 20 g/g and about 45 g/g. In embodiments of the present invention, the recycled SAP has a CRC, and wherein the CRC is between about 25 g/g and about 40 g/g. In embodiments of the present invention, the recycled SAP has a CRC, and wherein the CRC is between about 30 g/g and about 35 g/g.

In embodiments of the present invention, the recycled SAP has an AAP, and wherein said AAP is between about 15 g/g and about 40 g/g. In embodiments of the present invention, the recycled SAP has an AAP, and wherein said AAP is between about 20 g/g and about 35 g/g. In embodiments of the present invention, the recycled SAP has an AAP, and wherein said AAP is between about 25 g/g and about 30 g/g.

### VI Methods

### SAP “GIC 31187” Preparation

Deionized water with resistance >5 MΩ·cm at 25° C., and ice made from the deionized water are used. A sample of about 100 g of the ice is melted in a 250 mL glass beaker (VWR International Ltd, Leicestershire, UK; part #LENZ07001049) and the conductivity is measured (e.g., via COND 70 INSTRUMENT without CELL, #50010522, equipped with Cell VPT51-01 C=0.1 from XS Instruments (Carpi MO, Italy) or via LF 320/Set, #300243 equipped with TetraCon 325 from WTW (Xylem Inc., Rye Brook, N.Y., USA)) as <1.6 μS/cm at 0° C.

A 20 L resin kettle (equipped with a four-necked glass cover closed with septa, suited for the introduction of a thermometer and syringe needles) is charged with about 8713.2 g of ice prepared as described above. A magnetic stirrer, capable of mixing the whole content (when liquid), is added and stirring is started (e.g., elliptic magnetic stir bar from VWR, part #442-0507). Stirring can take place at 250-600 rpm. 315.6 g of deionized water is taken to dissolve 33.52 g of “PEG700-DA” (e.g., poly(ethylene glycol)-diacrylate with number average molecular weight of about 700 g/mol, from Sigma-Aldrich, CAS #26570-48-9) in a 500 mL glass beaker. The glass beaker with the “PEG700-DA” solution is covered with parafilm and set aside. 250.0 g of deionized water is used to dissolve 5.175 g of “KPS” (potassium persulfate from Sigma-Aldrich, CAS #7727-21-1) in a 500 mL glass beaker. To this solution, about 0.208 g of 1 wt % aqueous solution of hydrogen peroxide (prepared by dilution with deionized water of 30 wt % aqueous hydrogen peroxide solution obtained from Sigma-Aldrich, CAS #7722-84-1) are added. The so-obtained “KPS” solution is closed and set aside. This solution must be used within 6 h of preparation. 50.0 g of deionized water are used to dissolve 1.128 g of ascorbic acid (from Sigma-Aldrich, CAS #50-81-7) in a 100 mL glass vial with a plastic cap. The solution “ascorbic acid” is closed and set aside. 4599.600 g of glacial acrylic acid (GAA, CAS #79-10-7; Acrylic Acid for synthesis, from Merck, #800181) are added to the ice in the resin kettle while stirring is continued. A thermometer is introduced into the resin kettle and in total 3472.600 g of 50 wt % NaOH solution (for analysis, from Merck, #158793, CAS #1310-73-2) and about 250.0 g of ice (prepared from de-ionized water) are added subsequently in portions such that the temperature is in the range of about 15-30° C. The mixture is continuously stirred. The “PEG700-DA” solution is added to the mixture of acrylic acid (AA), NaOH solution, and ice at a temperature of about 15-30° C., while stirring is continued. The vessel that contained the “PEG700-DA” solution is washed twice with deionized water in an amount of about 3% of the “PEG700-DA” solution volume per wash. The wash water of both washing steps is added to the stirred mixture. Deionized water (the remaining amount required to achieve the total amount of (ice+water) of 11887.47 g) is added to the stirred mixture, e.g., ca. 2308.67 g of deionized water. Then, the resin kettle is closed, and a pressure relief is provided e.g., by puncturing two syringe needles through the septa. The solution is then purged vigorously with argon via an injection needle (stainless steel 304 syringe, 36 in. long, size 16 gauge from Sigma-Aldrich, part #Z152404-1EA) at about 0.4 bar while stirring at about 250-600 rpm. The argon stream is placed close to the stirrer for efficient and fast removal of dissolved oxygen. After about minimum 1 h and maximum 2 h of argon purging and stirring, the “ascorbic acid” solution is added to the reaction mixture at a temperature of about 20-25° C. via a syringe while stirring and argon purging is continued. Within 1 min, the “KPS” solution is also added via funnel through one of the 4 necks in the glass cover, which is quickly covered after the addition of “KPS” is completed. After the initiator solutions (“ascorbic acid” and “KPS” solutions) are mixed with the reaction mixture, stirring and argon purging is continued but the purging needle is moved above the reaction mixture and temperature is recorded. As the polymerization starts, indicated by temperature rise in small steps, and more specifically after the gel point, characterized by sudden increase in viscosity, stirring is stopped. The temperature is monitored; typically, it rises from about 23° C. to about 70-95° C. within 60 min. Once the temperature reaches a maximum (the reaction mixture can reach for example up to about 105° C.) and starts dropping, the resin kettle is transferred into a circulation oven (Binder FED 720) and kept at about 60° C. for about 20 h.

After the polymerization completion time in the circulation oven, the latter is switched off and the resin kettle is allowed to cool down to about 20° C. to 40° C. while remaining in the oven. After that, the gel is removed and broken manually or cut with scissors into smaller pieces. The gel is ground with a grinder (X70G from Scharfen with Unger R70 plate system: 3 pre-cutter kidney plates with straight holes at 17 mm diameter), put onto perforated stainless steel dishes (hole diameter 4.8 mm, 50 cm×50 cm, 0.55 mm caliper, 50% open area, from RS; max. height of gel before drying: about 3 cm) and transferred into a circulation oven (e.g., Binder FED 720) equipped with a condensate trap from DAMM (condensation via cooling below dew point via heat exchanger) to dry the circulation air, cooled to 5° C. via a thermostat (Julabo FP 50)) at about 120° C. for about 20 h. The dried gel is then ground using a centrifuge mill (e.g., Retsch ZM 200 with vibratory feeder DR 100 (setting 50-60), interchangeable sieve with 1.5 mm opening settings, rotary speed 8000 rpm). The milled polymer is then sieved via a sieving machine (e.g., AS 400 control from Retsch with sieves DIN/ISO 3310-1 of 150 μm and 710 μm at about 250 rpm for about for 10 min) to a sieve cut which contains >90 wt % of the materials between 150 and 850 μm to obtain the Base Polymer “SK-002-A”. The particles passing through the 150 μm sieve were collected under the name “RD 5717”. The hereto described procedure is repeated two more times for stockpiling of SAP particles with cut 150-710 μm under the names “SK-002-E” and “SK-002-K”, respectively. The corresponding cuts below 150 μm were collected as described for “SK-002-A” and under the names “GIC 31749” and “GIC 30266”, respectively. To make the “GIC 31187” material, the materials “RD 5717”, “GIC 31749”, and “GIC 30266”, all with particle size under 150 μm, were combined together and sieved again, as described above, but with sieves DIN/ISO 3310-1 with mesh sizes 63 μm and 150 μm, respectively.

### SAP “GIC 31187” Properties

The so obtained SAP material was analyzed for capacity, moisture, and extractable polymer using the Centrifuge Retention Capacity (CRC) test method (EDANA method WSP 241.2.R3), moisture test method (EDANA method WSP 230.2.R3), and extractable polymer (amount of extractables) test method (EDANA method WSP 270.2.R3), respectively. The results were as follows: CRC=50.3 g/g; Moisture=0.3 wt %; and Extractable Polymer=15.03 wt %.

### Total Energy Calculations

The total energy is the electric energy that is supplied to the HTT reactor and is based on the voltage and amperage of the HTT reactor, and the residence time of the feed stream.

### Specific Energy Calculations

The specific energy is the energy dissipated in the feed stream and is used to convert SAP to PAA.

### Molecular Weight Distribution (MWD) Analysis

It is done using Gel Permeation Chromatography (GPC) with Multi-Angle Light Scattering (MALS) and Refractive Index (RI) detection. Samples are made at concentration of 1 mg/mL in 0.1M NaNO₃/0.02 wt % Sodium Azide (NaN₃) with a gentle mixing at room temperature for overnight hydration. Samples are then filtered through a 0.8 μm filter before the GPC-MALS/RI analysis. The absolute MWD distribution is calculated using do/dc value of 0.15.

The foregoing description is given for clearness of understanding only, and no unnecessary limitations should be understood therefrom, as modifications within the scope of the invention may be apparent to those having ordinary skill in the art.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, comprising any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for degrading a superabsorbent polymer (SAP) to poly(acrylic acid) (PAA) comprising flowing a feed stream comprising water and said SAP into an inlet of a hydrothermal treatment (HTT) reactor and producing a product stream comprising said PAA at an outlet of said HTT reactor; wherein said HTT reactor is at an HTT reactor temperature and at an HTT reactor pressure; wherein said HTT reactor temperature is higher than about 250° C. and said HTT reactor pressure is higher than about 1 MPa; wherein said SAP in said feed stream is at a concentration greater than about 1 wt %; and wherein said degradation of said SAP to said PAA requires a total energy of less than about 50 MJ/kg SAP.

2. The method of claim 1, wherein said total energy is less than about 16 MJ/kg SAP.

3. The method of claim 1, wherein said SAP has degree of neutralization (DN) greater than about 50%.

4. The method of claim 1, wherein said SAP has DN between about 65% and about 75%.

5. The method of claim 1, wherein said feed stream has a viscosity; wherein said product stream has a viscosity; wherein the ratio of the viscosity of the product stream to the viscosity of the feed stream is the viscosity ratio; and wherein the negative logarithm of said viscosity ratio is less than about 6.

6. The method of claim 1, wherein said feed stream has a viscosity; wherein said product stream has a viscosity; wherein the ratio of the viscosity of the product stream to the viscosity of the feed stream is the viscosity ratio; and wherein the negative logarithm of said viscosity ratio is less than about 4.

7. The method of claim 1, wherein said feed stream has a viscosity; wherein said product stream has a viscosity; wherein the ratio of the viscosity of the product stream to the viscosity of the feed stream is the viscosity ratio; and wherein the negative logarithm of said viscosity ratio is less than about 2.

8. The method of claim 1, wherein said PAA has a weight-average molecular weight less than about 2,000,000 g/mol.

9. The method of claim 1, wherein said PAA has a weight-average molecular weight less than about 1,000,000 g/mol.

10. The method of claim 1, wherein said PAA has a polydispersity index (PDI) less than about 4.

11. The method of claim 1, wherein said PAA is used to produce a recycled SAP; said SAP comprises PAA at a concentration; and wherein said PAA concentration is less than about 30%.

12. The method of claim 1, wherein said PAA is used to produce a recycled SAP; wherein said recycled SAP has an amount of extractables; and wherein said amount of extractables is less than about 15%.

13. The method of claim 1, wherein said PAA is used to produce a recycled SAP; wherein said recycled SAP has a swelling ratio; and wherein said swelling ratio is greater than about 45 g/g.

14. A method for degrading a superabsorbent polymer (SAP) to poly(acrylic acid) (PAA) comprising flowing a feed stream comprising water and said SAP into an inlet of an HTT reactor and producing a product stream comprising PAA at an outlet of said HTT reactor; wherein said HTT reactor is at an HTT reactor temperature and at an HTT reactor pressure; wherein said HTT reactor temperature is higher than about 250° C. and said HTT reactor pressure is higher than about 1 MPa; wherein said SAP in said feed stream is at a concentration greater than about 1 wt %; wherein said degradation of said SAP to said PAA requires a total energy of less than about 16 MJ/kg SAP; and wherein said PAA has a weight-average molecular weight less than about 1,000,000 g/mol.

15. A method for degrading a superabsorbent polymer (SAP) to poly(acrylic acid) (PAA) comprising flowing a feed stream comprising water and said SAP into an inlet of an HTT reactor and producing a product stream comprising PAA at an outlet of said HTT reactor; wherein said HTT reactor is at an HTT reactor temperature and at an HTT reactor pressure; wherein said HTT reactor temperature is higher than about 374° C. and said HTT reactor pressure is higher than about 22.064 MPa; wherein said SAP in said feed stream is at a concentration greater than about 5 wt %; wherein said degradation of said SAP to said PAA requires a total energy of less than about 16 MJ/kg SAP; and wherein said PAA has a weight-average molecular weight less than about 1,000,000 g/mol.

16. The method of claim 15, wherein said feed stream has a viscosity; wherein said product stream has a viscosity; wherein the ratio of the viscosity of the product stream to the viscosity of the feed stream is the viscosity ratio; and wherein the negative logarithm of said viscosity ratio is less than about 4.

17. The method of claim 15, wherein said SAP has DN between about 65% and about 75%.
